(19) United States
(12) Patent Application Publication
(10) Pub. No.: US 2006/0294343 A1
(43) Pub. Date: Dec. 28, 2006

(54) Realtime compression of microprocessor execution history

(75) Inventor: Richard E. Rejmaniak, Pennsburg, PA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 11/167,529

(22) Filed: Jun. 27, 2005

(51) Int. Cl. G06F 9/44

(52) U.S. Cl. 712/227

(57) ABSTRACT

A trace compression unit is included in a processor system that has a processor core and an external system memory. The trace compression unit encrypts the processor core execution history into compressed trace record that is stored in external memory using one or more control to define a storage location in external system memory for the compressed trace record. By encrypting the processor core execution history into compressed trace record that is stored in external memory, the execution history may be captured without external test equipment, and there is no need for on-chip memory to record execution history.

### BACKGROUND OF THE INVENTION

1. Field of the Invention

The present invention relates generally to the field of data processing technology. In one aspect, the present invention relates to the acquisition of execution history information for monitoring the operation and performance of a central processing unit or processor in a computer system.

2. Related Art

As is known, computer systems use a processor or central processing unit (CPU) to perform data processing by sequentially reading and executing program instructions that are stored in external or cache memory. However, computer systems increasingly include more and more circuit functionality in a single integrated circuit chip in the move to System-On-Chip (SOC) solutions, making it more difficult to design and properly test or validate the overall system design, especially where the overall interaction of different circuit function subsystems is difficult to model because of the increasingly reduced visibility of subsystem interaction. Nevertheless, such an understanding is important if the performance of the overall system is to be improved or if any potentially erroneous behavior is to be detected and corrected.

One of the methods for testing the internal operation of a computer system is tracing the behavior of the CPU by recording the execution path of instructions and data executed by the CPU. Conventional solutions for tracing the execution path of a CPU in an SOC integrated circuit device use an external device (e.g., a debug device, such as an In-Circuit Emulator (ICE) system) to track the timing of the CPU during execution. To test the integrated circuit device, a user program is read into the CPU for execution, and trace data generated by the CPU during execution is collected by the debug device. Checking the collected trace data, which is the execution history data on the CPU, shows how the CPU performed data processing during execution of the user program. However, this solution can fail to detect the execution of instructions or data contained in the internal cache memory.

There are techniques available for tracing the execution path of a processor that is executing out of an internal memory cache, but each technique has technical drawbacks. For example, a one technique for tracing a processor is known as code instrumentation, which turns the cache “off” to force external viewing of the execution sequence. This solution may be performed in hardware or software by setting compiler switches that force the insertion of code to turn off the caches during execution. Some debuggers (such as Windriver's VisionICE system) allow dynamic code instrumentation by having the debugger insert the code into target memory to turn off the caches. However, because this slows the processor down substantially, the system behavior is affected, possibly negating the situation that is attempting to be traced. In another technique, the execution path is provided to an external set of pins on the processor for capture by an external debug device. This requires expensive external test equipment and is not available outside of the development laboratory. Another available technique is to maintain a special dedicated trace storage buffer within the device which records the execution history of the processor. While there are benefits to this approach, such dedicated storage memories are prohibitively expensive and capture only a limited portion of the execution history due to their limited size.

Therefore, a need exists for a method and apparatus that provides an effective and efficient way to trace the execution path history of a processor or CPU in a complex SOC computer system. In addition, a need exists for a method and apparatus that can be used during the design and validation of complex processor-based systems. Moreover, a need exists for a testing method and apparatus that can be used outside of the laboratory and that does not require expensive external test equipment that is not available outside of the development laboratory. There is also a need for a better testing system that is capable of performing the above functions and overcoming these difficulties using circuitry implemented in integrated circuit form. Further limitations and disadvantages of conventional systems will become apparent to one of skill in the art after reviewing the remainder of the present application with reference to the drawings and detailed description which follow.

### SUMMARY OF THE INVENTION

Broadly speaking, the present invention provides an improved method and system for tracing of the execution history of a processing unit—such as a programmable microcontroller (MCU), central processing unit (CPU) or digital signal processor (DSP)—by encrypting the execution history into a compressed trace record for real time capture and storage. By compressing the execution history of a microprocessor down to a list of change-of-flow destinations and the instruction count between change-of-flow instructions, it is possible to reduce the information flow of a high-speed processor to fit within the bandwidth of the attached system memory. The compressed representation of the execution history may be efficiently stored in system memory without requiring a large on-chip memory to store the execution history and without requiring an external debug device to capture the data.

In accordance with various embodiments of the present invention, a method and apparatus provide for real time compression of a processor execution history by using a trace compression unit to record a compressed execution history of a processing unit in a main memory, such as system SDRAM. The trace compression unit includes compression logic that compresses an execution history for the processing unit into a compressed byte stream that is stored in the main memory as an expandable opcode. The compression logic monitors completed instructions from the processing unit and detects branch instructions, tracks a count of instructions between branch instructions and tracks destination information associated with said branch instructions. Based on this information, the compression logic generates a compressed trace history (e.g., a list of change-of-flow instructions, destination addresses and an instruction count between change-of-flow instructions). The trace compression unit also includes data gathering logic that retrieves a memory address identifying the location in the main memory where the compressed byte stream is to be stored, where the memory address may be stored in one or more control registers in the processing unit. In a selected embodiment, the data gathering logic gathers the compressed byte stream into a word length that fills a system bus connecting the processing unit to the main memory. The data gathering logic may also generate a trigger signal based on a comparison of an operating condition of the processing unit with one or more trigger conditions stored in the one or more control registers. In response to the trigger signal, the execution history compression may be started, stopped, reset or frozen.

The objects, advantages and other novel features of the present invention will be apparent from the following detailed description when read in conjunction with the appended claims and attached drawings.

### BRIEF DESCRIPTION OF THE DRAWINGS

FIG. 1 shows a block diagram of a data processor system-on-a-chip application in which selected embodiments of the present invention may be implemented.

FIG. 2 depicts an example technique for encrypting execution history information in accordance with selected embodiments of the present invention.

FIG. 3 illustrates how CPU control registers may be used to store a compressed processor execution history in the main memory in accordance with selected embodiments of the present invention.

FIG. 4 is a logic diagram of a method for compressing and storing trace information in accordance with selected embodiments of the present invention.

### DETAILED DESCRIPTION

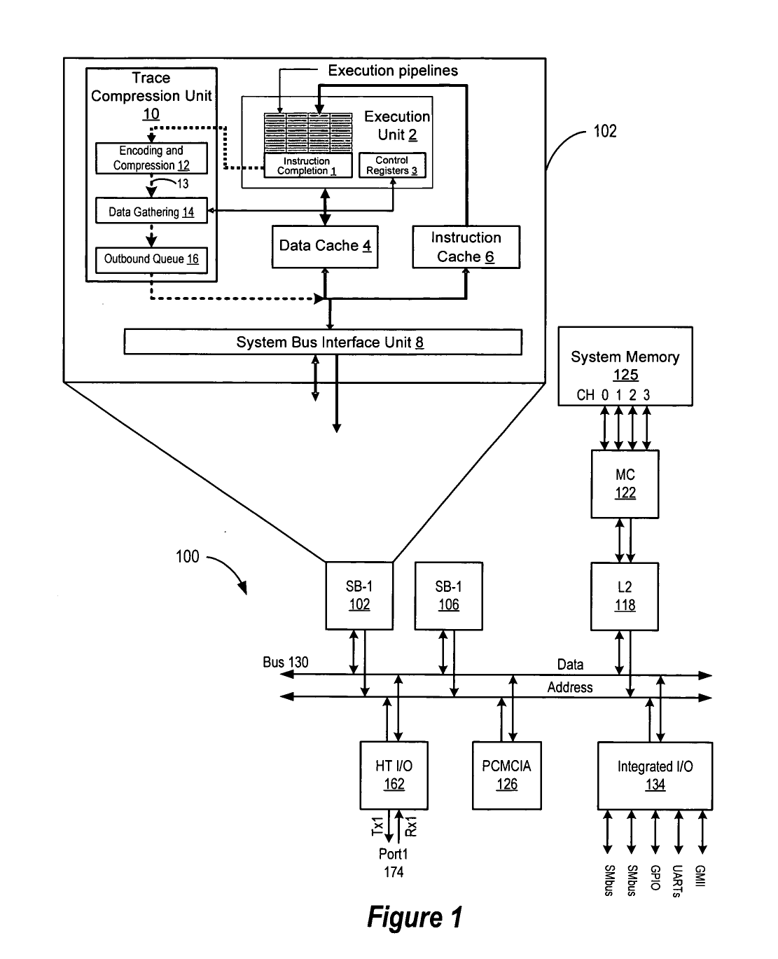

An apparatus and method in accordance with the present invention provide a system for encrypting and/or compressing the execution history in real time and emitting the encrypted/compressed byte stream for storage in the system memory. A system level description of the operation of a multiprocessor switching system embodiment of the present invention is shown in FIG. 1, though it will be appreciated that the present invention can be used with any programmable microcontroller, central processing unit or digital signal processor, including single or multiple core systems. While various details are set forth in the following description, it will be appreciated that the present invention may be practiced without these specific details. For example, selected aspects are shown in block diagram form, rather than in detail, in order to avoid obscuring the present invention. Some portions of the detailed descriptions provided herein are presented in terms of algorithms or operations on data within a computer memory. Such descriptions and representations are used by those skilled in the field of processor-based computer systems to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

In FIG. 1, the multiprocessor system 100 implements multiple circuit functionalities, including a plurality of processing units 102, 106, a cache memory 118, memory controller 122 (which interfaces with on and/or off-chip system memory 125), an internal bus 130, an integrated I/O 134, and at least one packet based interface 162, such as a HyperTransport I/O interface. Any one or more of these functionalities, alone or in combination with other circuitry, may be integrated onto a single integrated circuit as a system on a chip configuration or as separate integrated circuits.

In the depicted configuration, the processors 102, 106 are joined to the internal bus 130, and may be designed to execute programs written to any instruction set architecture, such as the MIPS instruction set architecture (including the MIPS-3D and MIPS MDMX application specific extensions), the IA-32 or IA-64 instruction set architectures developed by Intel Corp., the PowerPC instruction set architecture, the Alpha instruction set architecture, the ARM instruction set architecture, or any other instruction set architecture. For example, each processing unit 102, 106 may be implemented as a 64-bit MIPS CPU. The processor system 100 may include any number of processors (e.g., as few as one processor, two processors, four processors, etc.). In addition, each processing unit 102, 106 may include a level 1 (L1) cache memory sub-system of an instruction cache and a data cache and may support separately, or in combination, one or more processing functions.

The internal bus 130 may be any form of communication medium between the devices coupled to the bus. For example, the bus 130 may include shared buses, crossbar connections, point-to-point connections in a ring, star, or any other topology, meshes, cubes, etc. In selected embodiments, the internal bus 130 may be a split transaction bus. (i.e., having separate address and data phases). The data phases of various transactions on the bus may proceed out of order with the address phases. The bus may also support coherency and thus may include a response phase to transmit coherency response information. The bus may employ a distributed arbitration scheme, and may be pipelined. The bus may employ any suitable signaling technique. For example, differential signaling may be used for high speed signal transmission. Other embodiments may employ any other signaling technique (e.g., TTL, CMOS, GTL, HSTL, etc.). Other embodiments may employ non-split transaction buses arbitrated with a single arbitration for address and data and/or a split transaction bus in which the data bus is not explicitly arbitrated. Either a central arbitration scheme or a distributed arbitration scheme may be used, according to design choice. Furthermore, the bus may not be pipelined, if desired. In addition, the internal bus 130 may be a high-speed (e.g., 128-Gbit/s) 256 bit cache line wide split transaction cache coherent multiprocessor bus that couples the processing units 102, 106, cache memory 118 and memory controller 122 (illustrated for architecture purposes as being connected through cache memory 118) together. The bus 130 may run in big-endian and little-endian modes, and may implement the standard MESI protocol to ensure coherency between the CPU cores 102, 106, their L1 caches, and the shared level 2 (L2) cache 118. In addition, the bus 130 may be implemented to support all on-chip peripherals, including a PCI interface 126, the integrated I/O 134, and the packet-based interface 162.

The cache memory 118 may function as an L2 cache for the processing units 102, 106. The memory controller 122 provides an interface to system memory, which, when the processor system 100 is an integrated circuit, may be off-chip and/or on-chip. The memory controller 122 is configured to access the system memory in response to read and write commands received on the bus 130. The L2 cache 118 may be coupled to the bus 130 for caching various blocks from the system memory for more rapid access by agents coupled to the bus 130. In such embodiments, the memory controller 122 may receive a hit signal from the L2 cache 118, and if a hit is detected in the L2 cache for a given read/write command, the memory controller 122 may not respond to that command. Generally, a read command causes a transfer of data from the system memory (although some read commands may be serviced from a cache such as an L2 cache or a cache in the processors 102, 106) and a write command causes a transfer of data to the system memory (although some write commands may be serviced in a cache, similar to reads). The memory controller 122 may be designed to access any of a variety of types of memory. For example, the memory controller 122 may be designed for synchronous dynamic random access memory (SDRAM), and more particularly double data rate (DDR) SDRAM. Alternatively, the memory controller 122 may be designed for DRAM, DDR synchronous graphics RAM (SGRAM), DDR fast cycle RAM (FCRAM), DDR-II SDRAM, Rambus DRAM (RDRAM), SRAM, or any other suitable memory device or combinations of the above mentioned memory devices.

In the depicted processor system 100, the example SB-1 CPU core 102 includes at least one instruction execution unit 2 which maintains and executes instructions in one or more execution pipelines. The execution unit 2 includes detection circuitry 1 and control registers 3 (described below), and is coupled to a data cache 4 and/or an instruction cache 6, each of which is coupled to send data and/or instructions back to the execution unit 2. The CPU core 102 also includes a trace compression unit 10 which operates in conjunction with detection circuitry 1 and control registers 3 in the execution unit 2 to intercept desired execution history information, compress this information and write it out in compressed form to the system memory. The execution unit 2, data cache 4, instruction cache 6 and trace compression unit 10 are coupled to a system bus interface unit 8 for interface to the bus 130.

In the illustrated implementation, the trace compression unit 10 uses an encoding and compression logic module 12 to compress the execution history of the CPU core 102 down to a list of change-of-flow instructions, destination addresses and the instruction count between change-of-flow instructions. This compression approach takes advantage of the fact that program behavior typically includes between 10-15 percent of change-of-flow instructions, so that a program flow can be reduced to the changes in the program counter due to branching, jumping to subroutines and servicing interrupts and exceptions, making it unnecessary to report every instruction's address but rather only report the change of flow. For example, when the CPU core 102 encounters a jump, branch, exception, or exception return instruction, a series of bytes is stored to memory with an encrypted reason for the change of flow, the destination address, and a count the number of instructions prior to the change-of-flow instruction. With this compressed representation of the execution history, it is possible to reduce the information flow of a high-speed processor to fit within the bandwidth of the attached system memory.

In operation, as instructions from the execution pipeline(s) are executed by the execution unit 2, the completion of the instruction execution is detected by the detection circuit 1 and is forwarded to the trace compression unit 10. At the trace compression unit 10, the encoding and compression logic module 12 detects branch instructions, tracks the number of instructions between branch instructions and the destination of branch instructions, and generates an encoded or compressed byte stream 13. Next, the data gathering module 14 gathers the encoded byte stream 13 into words that fill the inherent size of the system bus 130 (e.g., 128 bits, 256 bits, etc.). In addition, the data gathering module 14 retrieves the memory address from the control registers 3 in the CPU core for where the encoded/compressed data is to be stored in the system memory 125. At the outbound queue 16, data is collected to meet the size requirements of a cache line push, and then a data write to the system memory 125 is scheduled through the same system bus interface unit 8 that is used by the execution unit 2.

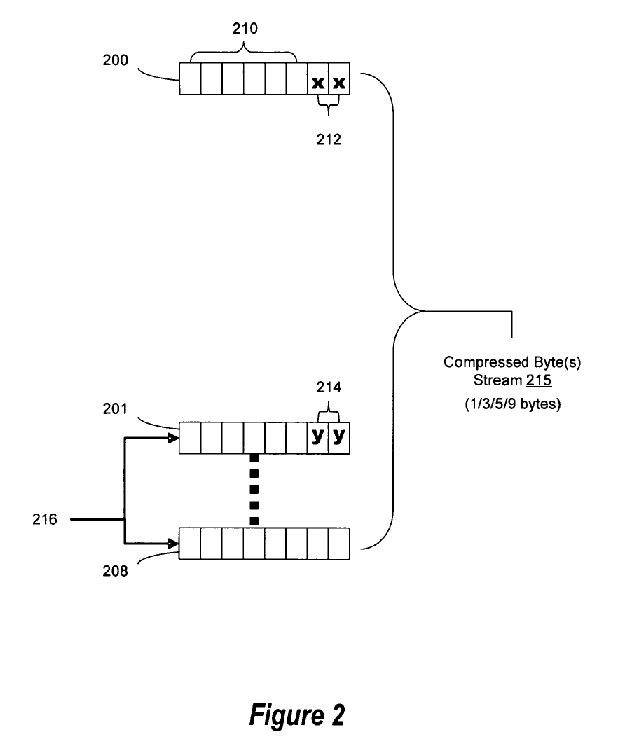

Turning now to FIG. 2, there is depicted an example technique for encrypting execution history information in accordance with selected embodiments of the present invention whereby the compression logic constructs a compressed stream of bytes 215 indicating the path of the processor or CPU core. While a variety of encryption algorithms may be suitably employed to compress the execution history, a selected embodiment uses an expandable opcode format to minimize the overall byte count. With this approach, a reduced-length opcode (e.g., one byte in length) is used to signal that there is no change-in-flow instruction, while a longer-length opcode (e.g., in lengths of three bytes, five bytes and nine bytes) is used to signal that there is a change-in-flow instruction, to identify the type of change-in-flow instruction, to specify a destination address for the change-of-flow instruction and to specify the number of instructions between change-of-flow instructions. This approach can be implemented by exploiting the fact that the instructions on modern RISC processors are 32 bits in size, meaning that the lowest two address bits of any instruction will be zero. As illustrated in FIG. 2, this allows the two least significant bits of each address byte (e.g., 200, 201) to be used to encode the size and meaning of the (multi-) byte stream generated by the compression logic.

For example, in a first byte 200, the size of the compressed byte stream 215 may be indicated by a size field 212 (e.g., bit positions 0 and 1 in the first byte 200), while the number of instructions between change-of-flow instructions is indicated by a run field 210 (e.g., bit positions 2-7). If the size field 212 has a first value (e.g., 00), then this signals that the compressed byte stream 215 will be only one byte in length, indicating that no change-of-flow instructions were detected. Thus, when both of the lower bits 212 are zero, this indicates that there were more than 63 instructions since the last change-of-flow, and this count is continued in another byte of the same format.

When the CPU core encounters a change-of-flow instruction, the compression logic uses a longer byte stream used to specify the type of change-of-flow instruction and its associated destination address. The longer byte stream may include a first byte 200 which uses the size field 212 to signal other properties for the compressed byte stream 215. For example, if the size field 212 has a second value (e.g., 01), then this signals detection of a change-of-flow instruction with a 16-bit destination address which will be represented by a compressed byte stream 215 that is three bytes in length. Alternatively, if the size field 212 has a third value (e.g., 10), then this signals detection of a change-of-flow instruction with a 32-bit destination address which will be represented by a compressed byte stream 215 that is five bytes in length. Finally, if the size field 212 has a fourth value (e.g., 11), then this signals detection of a change-of-flow instruction with a 64-bit destination address which will be represented by a compressed byte stream 215 that is nine bytes in length. As will be appreciated, different byte stream and/or size field lengths may be used to identify desired information about a detected branch or change-of-flow instruction.

In addition to the first byte 200, the longer byte stream may include one or more additional bytes to specify other properties of the compressed byte stream 215. For example, if the first byte 200 indicates that a 16-bit destination address is associated with a detected change-of-flow instruction, two additional bytes 201 and 208 are included in the compressed byte stream 215. These bytes 201, 208 include a type field 214 (e.g., bit positions 0 and 1 of the second byte 201) and a destination address field 216 (e.g., bit positions 2-7 of the second byte 201 and bit positions 8-15 of the third byte 208). The type field 214 may be used to identify the reason for the change-of-flow instruction, such as by identifying a branch or jump with a first value (e.g., 00), identifying that a synchronous exception was taken with a second value (e.g., 01), identifying that an interrupt exception was taken with a third value (e.g., 10), and identifying that an exception return occurred with a fourth value (e.g., 11).

As for the destination address field 216, all or part of the unused additional bytes in the compressed byte stream 215 (e.g., bit positions 2-15 of bytes 201, 208) may be used to identify the associated destination address by exploiting the fact that the lowest two address bits of any instruction will be zero. Thus, with a three-byte compressed byte stream 215, bit positions 2-15 of bytes 201, 208 specify bit positions 2-15 of the 16-bit destination address, with bit positions 0 and 1 of the destination address being zero.

While the compressed byte stream 215 may use additional bytes to encode change-of-flow instructions associated with longer destination addresses, the same encoding approach applies. For example, if the first byte 200 indicates that a 32-bit destination address is associated with a detected change-of-flow instruction, four additional bytes are included in the compressed byte stream 215, including a second byte 201 and a fifth byte 208. These four additional bytes include a type field 214 (e.g., bit positions 0 and 1 of the second byte 201) and a destination address field (e.g., bit positions 2-31 of the second through fifth bytes). Likewise, if the first byte 200 indicates that a 64-bit destination address is associated with a detected change-of-flow instruction, eight additional bytes are included in the compressed byte stream 215, including a second byte 201 and a ninth byte 208. These eight additional bytes include a type field 214 (e.g., bit positions 0 and 1 of the second byte 201) and a destination address field (e.g., bit positions 2-63 of the second through ninth bytes).

As seen from the foregoing, unless the processor core detects a change-of-flow instruction, it will simply keep track of the number of instructions since the last change-of-flow instruction. When the number of instructions since the last change-of-flow instruction exceeds a predetermined number (e.g., 63 instructions), the encryption/compression logic generates encrypted trace data which includes a first byte of data with an indication of the number of instructions since the last change-of-flow instruction and an indication that no change-of-flow instruction has been detected yet. Once a change-of-flow instruction is detected, the encryption/compression logic generates encrypted trace data which includes at least a first byte of data 200 with an indication of the number of instructions since the last change-of-flow instruction and a size indication for the total encrypted trace data. The encryption/compression logic sets the size indication based on the destination address associated with the detected change-of-flow instruction so that larger addresses require more bytes, and smaller addresses require fewer bytes. The encryption/compression logic may also include one or more additional bytes of data in the encrypted trace data which identify the specific type of change-of-flow instruction and the associated destination address.

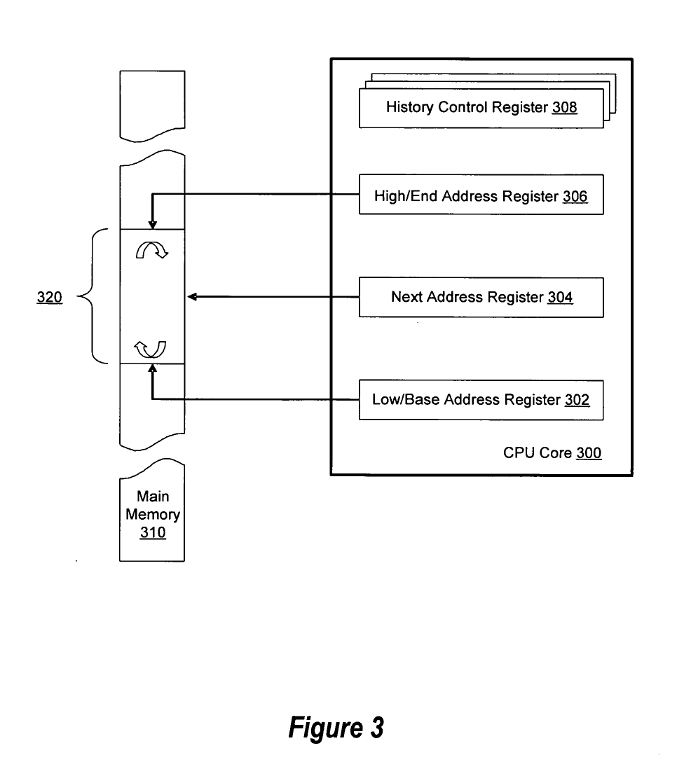

After the execution history has been encrypted, the compressed byte stream of trace data may be stored in the attached system memory in real time by using a plurality of software-accessible control registers in the processor to specify the addresses for storing the encrypted trace data in the system memory. An illustrative embodiment of such a memory allocation technique is depicted in FIG. 3 which shows how control registers may be used to control the storage of a compressed processor execution history in the main memory in accordance with selected embodiments of the present invention. In particular, the CPU core 300 includes one or more software accessible control registers for identifying and/or tracking an instruction history portion 320 of the main memory 310 to be used for storing the encrypted or compressed trace data.

As depicted, the CPU core 300 includes two address storage registers. The first of these registers 302 is used for storing a base address and the second register 306 is used for storing a limit or end address. Together, these two registers 302, 306 define the instruction history portion 320 of the system memory 310 into which the trace compression unit will output compressed trace data. Alternatively, the instruction history portion 320 could be defined by storing its base address and size. In addition, the instruction history portion 320 of the main memory 310 may be implemented as a circular queue, where the outer limits of the queue 320 are specified by the first register 302 (e.g., a low register that specifies a low address in the memory 310) and the second register 306 (e.g., a high register that specifies a high address in the memory 310). With a circular queue, the storage of the compressed byte stream of trace data circles back to the memory location specified by the low register 302 once the memory location specified by the high register 306 is filled, thereby writing over previously-stored compressed trace data. Low and high registers 302, 306 may be set by software to assign the memory region which will store the encrypted or compressed trace data.

An additional control register 304 may also be used to specify a pointer or address location for the next address in the queue where the next byte(s) of encrypted trace data are to be stored. As will be appreciated, the address value stored in control register 304 may be initialized by the software and updated by logic in the trace compression unit as it stores data into the main memory 310. In addition or in the alternative, the address value stored in control register 304 may be incremented to increase the address value in control register 304 after each compressed byte stream of trace data is stored in accordance with the size of the previous output. Incrementing the address in the control register 304 after each output ensures that the next output is written to a fresh memory address, rather than overwriting an earlier output from trace compression unit.

In order to activate and deactivate the encryption and storage of trace data, one or more history control registers 308 may be provided which starts and/or stops the recording of encrypted trace data under software control. The history control register 308 can also assign on-chip breakpoint and watch point registers to act as stop and start triggers for controlling the trace compression unit. As will be appreciated, watch point and breakpoint triggering both react to a read/write/execute by the processor to a single memory address, or a range of addresses. In a watch point, a signal is raised to indicate that this event has occurred. Such a signal could be sent to the history logic to control recording. In addition, this signal may appear on an external pin for use by external debug equipment, as well as triggering an exception to the program flow. Any one or more of these responses to a watch point is optional. A breakpoint is a watch point with the added aspect that the processor stops program execution at the point of the trigger, and places itself into a state where an external piece of test equipment can take over control of the system.

In accordance with various embodiments of the present invention, breakpoint and watch point triggering may optionally be used to start, stop, reset, or freeze the collection of data based on the processor attempting to read, write, or execute an instruction from a particular address. Stopping the collection of data allows restarting without resetting the logic. An example of such options would be that the registers would be set to start collection when execution entered an area of memory that is in use by the application program. To avoid filling the history buffer with extraneous data, the history could be programmed to stop when the execution path of the processor entered an area of memory in use by the operating system. History recording would then be restarted when the processor again entered the application area of memory. Freezing the collection of data is different from stopping in that freezing requires the collection system to be reset to be able to restart collection. A freeze could occur if the processor attempted to access a forbidden or unexpected area of memory. At this point, the history buffer would probably contain the erroneous instruction(s), in which case the user would not want any errant execution of the processor at this point to restart the history recording and overwrite the captured problem. To avoid this, the software could perform a reset operation before it could reset the history recording logic.

In accordance with various embodiments of the present invention, triggering may be controlled by a set of control registers inside the CPU, similar in nature to the registers that control the memory locations for the storage of the compressed execution history. In a MIPS architecture embodiment, the SPR control registers can perform this function. In an example implementation, a triggering event to start the encryption and storage of execution history data could be a target range of memory addresses that are stored as upper and lower address values in control registers. Alternatively, the watch point register may store an address which, when accessed by the processor, causes an interrupt to issue, starts the trace compression recording operations or otherwise triggers the start of debug operations.

In operation, the desired address and control values are written into the control registers 302-308 by the trace compression unit. The address and control values stored in the control registers 302-308 may also be made accessible for read-out by the trace compression unit or some other external program or utility.

As described herein, the trace compression unit may be used to capture and compress diagnostic information for storage in the system memory. This has several important benefits. Firstly it avoids the need for any dedicated memory capacity within the trace compression unit or integrated circuit itself. In addition, the compressed diagnostic or trace data from a high-speed processor may be stored in real time in the external system memory within the existing system bus interface bandwidth. In addition, by storing the compressed trace information in external memory, the trace data may be readily accessed and decompressed for use by diagnostic programs running on the processor system or externally. Another important advantage when multiple trace compression units are used to monitor multiple processor cores is that the diagnostic data from the different trace compression units may be output to different locations in the system memory. While the ability to remotely control and read the storage of encrypted or compressed trace data is useful in a test environment, it may also be advantageously employed to maintain a more complete diagnostic record of an integrated circuit device out in the field where there is no external debug device available. For example, the compressed trace history may be constantly recorded in the system memory by the integrated circuit, or may be recorded on some other predetermined basis. Subsequently, the recorded trace data may be retrieved from the system during the performance of remote diagnostics on the integrated circuit. By storing compressed trace data in the system memory, a larger portion of the execution history may be retrieved, where the quantity of the execution history that is recorded is limited only by the system memory allocation for the instruction history portion of the system memory to be used for storing the encrypted or compressed trace data.

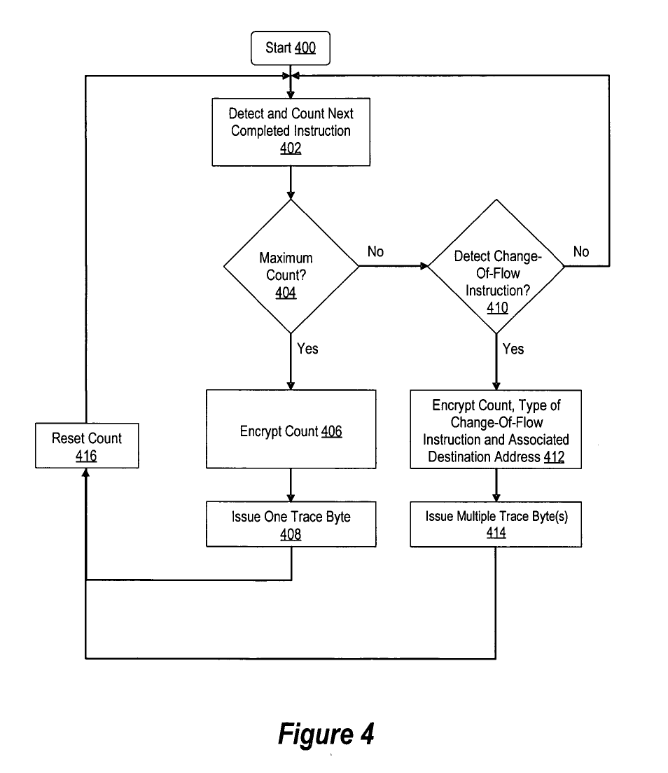

Turning now to FIG. 4, a method for compressing and storing trace information in accordance with the present invention is illustrated. According to the described methodology, the processor execution history is encrypted into a compressed trace record. Because this reduced or compressed representation of the instruction history may be stored in external memory in real time, the execution history may be effectively captured without external test equipment, and there is no need for on-chip memory to record execution history.

The method begins at step 400, where the CPU core is processing instructions. At step 402, each completed instruction execution is detected and a count is incremented. If the detected instruction does not reach the maximum count (negative outcome to decision 404) and is not a change-of-flow instruction (negative outcome to decision 410), then the process restarts by waiting for the next completed instruction (return to step 402). However, when the number of completed instructions reaches a maximum count without including a change-of-flow instruction (affirmative outcome to decision 404), then the count of completed instructions is encrypted at step 406 and a first trace opcode is issued at step 408. As described above, the first trace opcode may be a single byte of data which includes a size field (indicating that the opcode is only one byte long) and a run field (indicating the number of completed instructions without a change-of-flow instruction being detected). After resetting the count (step 416), the process restarts by waiting for the next completed instruction (return to step 402).

In situations where the next detected instruction is a change-of-flow instruction (affirmative outcome to decision 410) that was detected before reaching the maximum count (negative outcome to decision 404), then the count of completed instructions is encrypted at step 412, along with the type of change-of-flow instruction and the associated destination address, and a second trace opcode is issued at step 414. As described above, the second trace opcode may be a multi-byte data stream which includes a size field (indicating the size of the entire second trace opcode), a run field (indicating the number of preceding completed instructions since the last change-of-flow instruction), a type field (indicating the reason for the change-of-flow instruction) and a destination address field (indicating the destination address associated with the change-of-flow instruction). After resetting the count (step 416), the process restarts by waiting for the next completed instruction (return to step 402).

As described herein and claimed below, a method and apparatus are provided for providing a dynamically encoding the execution history of a processor device into a compressed form that can be readily stored in system memory using the same interface that is used by the processor. The new technique may be used to capture instruction history trace data without requiring expensive external test equipment or on-board memory resources.

Although the described exemplary embodiments disclosed herein are described with reference to various processor systems, the present invention is not necessarily limited to the example embodiments which illustrate inventive aspects of the present invention that are applicable to a wide variety of processor systems. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A processor system, comprising:
a first processor unit for executing a sequence of instructions;
an external system memory coupled to the first processor unit; and
a trace compression unit for encoding the sequence of instructions executed by the first processor unit into compressed trace data.

2. The processor system of claim 1, where the compressed trace data comprises a sequential list of change-of-flow instructions and associated destination addresses contained within the sequence of instructions and an instruction count between change-of-flow instructions in the sequence of instructions.

3. The processor system of claim 1, further comprising a system bus coupled to the first processor unit and the external system memory, where the trace compression unit stores the compressed trace data in the external system memory using the system bus.

4. The processor system of claim 1, where the trace compression unit comprises:
a detection circuit for monitoring completion of instruction execution by the first processor unit and detecting branch instructions;
compression logic for encoding the sequence of instructions by counting how many instructions are completed between branch instructions and tracking each destination address of each branch instruction; and
an output generator for writing the compressed trace data to the external system memory.

5. The processor system of claim 1, further comprising at least a first control register for storing information specifying an output location in the external system memory for storing the compressed trace data.

6. The processor system of claim 1, further comprising at least a first control register for storing information specifying a circular queue in the external system memory for storing the compressed trace data.

7. The processor system of claim 1, wherein the trace compression unit encodes the sequence of instructions executed by the first processor unit into compressed trace data by generating a first data byte if the sequence of instructions contains no branch instructions, where the first data byte comprises a count of the number of instructions in the sequence of instructions.

8. The processor system of claim 1, wherein the trace compression unit encodes the sequence of instructions executed by the first processor unit into compressed trace data by generating a second data byte upon detecting a branch instruction in the sequence of instructions, where the second data byte comprises:
a count of the number of instructions in the sequence of instructions since a previous branch instruction; and
a destination address associated with the detected branch instruction.

9. The processor system of claim 8, where the second data byte comprises a type indication for the detected branch instruction.

10. The processor system of claim 1, wherein the trace compression unit constructs the compressed trace data using an expandable opcode format to minimize the overall byte count.

11. A trace compression unit for recording an execution history of a processing unit in a main memory, said trace compression unit comprising:
compression logic for compressing an execution history for the processing unit into a compressed byte stream; and
data gathering logic for retrieving a memory address from one or more control registers in the processing unit for where the compressed byte stream is to be stored in the main memory.

12. The trace compression unit of claim 11, where the compression logic comprises means for encoding the execution history of the processing unit into a compressed byte stream that can be within stored in a system SDRAM without an external debug device.

13. The trace compression unit of claim 11, where the compression logic detects branch instructions, tracks a count of instructions between branch instructions and tracks destination information associated with said branch instructions.

14. The trace compression unit of claim 11, where the compressed byte stream comprises a list of change-of-flow instructions, destination addresses and an instruction count between change-of-flow instructions.

15. The trace compression unit of claim 11, where the data gathering logic generates a trigger signal based on a comparison of an operating condition of the processing unit with one or more trigger conditions stored in the one or more control registers.

16. The trace compression unit of claim 15, where the compression logic starts, stops, resets or freezes execution history compression in response to the trigger signal.

17. The trace compression unit of claim 11, where the data gathering logic gathers the compressed byte stream into a word length that fills a system bus connecting the processing unit to the main memory.

18. The trace compression unit of claim 11, where the trace compression unit stores the compressed byte stream in the main memory as an expandable opcode.

19. A method for encoding a microprocessor execution history, comprising:
detecting an execution history of completed instructions executed by a microprocessor;
compressing the execution history down to a compressed trace history comprising a list of change-of-flow destinations and the instruction count between change-of-flow instructions; and
storing the compressed trace history in system memory.

20. The method of claim 19, where compressing the execution history further comprises encrypting a count of how many instructions are completed between change-of-flow instructions.
